(19) United States
(12) Patent Application Publication
(10) Pub. No.: US 2023/0182320 A1
(43) Pub. Date: Jun. 15, 2023

(54) Rapid Clamping System for Attaching Machine Tools to a Robot

(71) Applicant: FerRobotics Compliant Robot Technology GmbH, Linz (AT)

(72) Inventor: Ronald Naderer, Linz (AT)

(21) Appl. No.: 17/920,964

(22) PCT Filed: Apr. 22, 2021
(86) PCT No.: PCT/EP2021/060529

§ 371 Date: Oct. 24, 2022

(30) Foreign Application Priority Data
Apr. 24, 2020 (DE) 10 2020 111 292.0

(51) Int. Cl. B25J 15/04; B25J 11/00; B25J 15/00

(52) U.S. Cl. CPC B25J 15/0408; B25J 11/005; B25J 15/0019

(57) ABSTRACT

A rapid clamping system for mounting a tool or a machine tool on a manipulator is described. According to an exemplary embodiment, the rapid clamping system comprises the following: a clamping chuck with a base plate which is designed to be mounted on a flange which can be positioned by a manipulator; a tool holder which is designed for mounting on a machine tool, wherein the tool holder has a mounting plate which, in a locked state, lies against the base plate of the clamping chuck; two or more pins which are designed, in a mounted state, to align the mounting plate on the base plate and to prevent a movement of the mounting plate relative a toggle-type fastener which is designed to lock the tool holder on the base plate of the clamping chuck, wherein, in the locked state, the elastic element is deformed and brings about a pretensioning force between the base plate and the mounting plate.

### TECHNICAL FIELD

The present disclosure relates to a rapid clamping system for attaching machine tools to a robot.

### BACKGROUND

During the robot-supported machining of surfaces, a machine tool (e.g. a grinding machine, a drill, a milling machine, a polisher, etc.) is guided by a manipulator, for example, an industrial robot. While doing so, the machine tool can be coupled in various ways to the so-called “tool center point” (TCP) of the manipulator; the manipulator is generally able to adjust the TCP to virtually any position and orientation in order to move a machine tool along a trajectory, i.e. parallel to the surface of a work piece. Industrial robots are usually position-controlled, which makes it possible to move the TCP precisely along the desired trajectory.

In many applications, in order to obtain good results from robot-supported grinding or other surface machining processes, the processing force (grinding force) must be regulated. This is often difficult to achieve with sufficient precision using conventional industrial robots. The large, heavy arm segments of an industrial robot possess too much mass inertia for a closed-loop controller to be able to react quickly enough to fluctuations in the processing force. In order to solve these problems, a linear actuator, which is smaller (and lighter) than the industrial robot and can be arranged between the TCP of the manipulator and the machine tool to couple the TCP of the manipulator to the machine tool. The linear actuator only regulates the processing force (that is, the contact force of the machine tool against the work piece) during the machining of the surface, while the manipulator moves the machine tool, together with the linear actuator, along the desired trajectory in a position-controlled manner By regulating the force, the linear actuator can compensate (within given limits) for inaccuracies in the position and form of the machined work piece, as well as for inaccuracies in the trajectory of the manipulator. That said, robots do exist that are capable of controlling the processing force, even without the aforementioned linear actuator, by means of force- torque adjustment.

Various clamping systems are known that are suitable for attaching and removing various machine tools to and from a robot. Simple systems require that an operator manually replace the tools on the robot. In general, robots are expected to provide a high degree of precision and the clamping systems which are currently commercially available are relatively complex and quite expensive.

The inventors identified a need for an improved but a relatively simple rapid clamping system for attaching machine tools that operates with the precision required in many applications.

### SUMMARY

A rapid clamping system for mounting a tool or a machine tool onto a manipulator will be described herein. In accordance with one embodiment, the rapid clamping system comprises the following: a clamping chuck with base plate which is implemented to be mounted on a flange which is positionable by means of a manipulator; a tool holder, which is implemented to be mounted on a machine tool, whereby the tool holder comprises a mounting plate which, in a locked state, rests against the base plate of the clamping chuck; two or more pins which, when in a mounted state, are implemented to align the mounting plate on the base plate and to prevent a movement of the mounting plate relative to the base plate in a plane parallel to the base plate; at least one elastic element; and a toggle-type fastener which is implemented to lock the tool holder on the base plate of the clamping chuck, wherein, in locked state, the elastic element is deformed and brings about a pretensioning force between the base plate and the mounting plate.

### SHORT DESCRIPTION OF THE FIGURES

Various implementations will now be described in detail with reference to the examples illustrated in the figures. The illustrations are not necessarily true to scale and the embodiments should not be understood as being limited to the aspects illustrated here. Instead, importance is given to explaining the basic principles underlying the illustrated embodiments.

FIG. 1 is an exemplary schematic illustration of a robot-supported grinding apparatus with a grinding machine which is coupled to an industrial robot by means of a force-controlled linear actuator. The linear actuator effect a partial mechanical decoupling of the industrial robot and the grinding machine.

FIG. 2 is a perspective exploded view of an example of a rapid clamping system for attaching a machine tool to a robot.

FIG. 3 is a lateral view of the example from FIG. 2.

FIG. 4 is a perspective view of the rapid clamping system in a clamped state.

FIG. 5 illustrates the system of FIG. 4, including machine tool.

### DETAILED DESCRIPTION

Before various embodiments are described in detail, a general example of a robot- support grinding device will be described. It should be understood that the concepts described here may also be applied to other forms of surface machining (e.g. polishing, milling, drilling, etc.) and are not limited to grinding. With the rapid clamping system described here, virtually any components can be quickly attached to a robot.

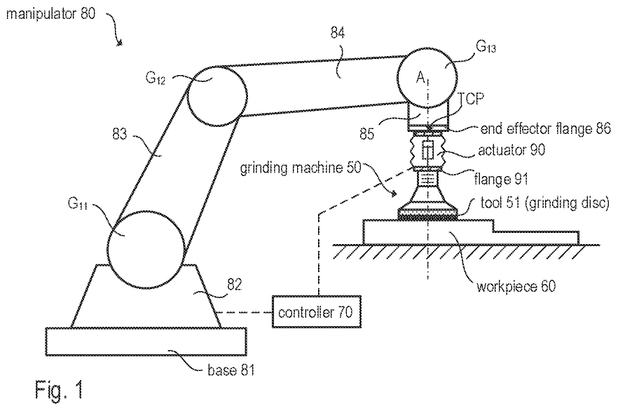

In accordance with FIG. 1, a robot-supported grinding device comprises a manipulator 80, for example an industrial robot, and a grinding machine 50 with a rotating grinding tool 51, whereby the latter may be coupled to the so-called tool center point (TCP) of the manipulator 1 via a linear actuator 20. Strictly speaking, the TCP is not a point, but rather a vector and can be described, for example, using three spatial coordinates (position) and three angles (orientation). In robotics, generalized coordinates (usually six joint angles of the robot) in the configuration space are also sometimes used to describe the position of the TCP and the position and orientation of the TCP are sometimes together referred to as “pose”. The position (incl. orientation) of the TCP as a time function defines the movement (referred to as “trajectory”) of the grinding tool. The center point of the end effector flange is often defined as the TCP of the robot, but this need not always be the case. The TCP may be any point (and, theoretically, may even lie outside of the robot) for which the robot can adjust its position and orientation. The TCP may also be defined as the origin of the tool coordination system.

In the case of an industrial robot having six degrees of freedom, the manipulator 80 may be constructed of four segments, 82, 83, 84 and 85, each of which is connected via the joints G₁₁, G₁₂ and G₁₃. The first segment 82 is usually rigidly attached to the base 81 (which, however, need not necessarily be the case). The joint G11 connects the segments 82 and 83. The joint G11 may be biaxial and allow for a rotation of the segment 83 around a horizontal axis of rotation (elevation angle) and around a vertical axis of rotation (Azimuth angle). The joint G12 connects the segments 83 and 84 and allows for a swivel movement of the segment 84 relative to the position of the segment 83. The joint G13 connects the segments 84 and 85. The joint G13 may be biaxial therefore allows (similar to the joint G11) for a swivel movement in two directions. The TCP is at a permanent position relative to segment 85, wherein the latter generally also comprises a rotational joint (not shown) which allows for a rotational movement of the end effector flange 86 arranged on the segment 85 around a longitudinal axis A of the segment 85 (in FIG. 1 designated with a dash-dotted line, in the example shown here also corresponds to the axis of rotation of the grinding tool). An actuator (e.g. an electric motor) which can effect a rotational movement around the respective joint axis is assigned to very axis of a joint. The actuators in the joints are controlled by a robot controller 70 according to a robot program. Various industrial robots/manipulators and their respective controllers are widely known and will therefore not be discussed here in greater detail.

The manipulator 80 is generally position-controlled, i.e. the robot controller can determine the pose (position and orientation) of the TCP and can move it along a previously defined trajectory. One sees in FIG. 1 the longitudinal axis of the segment 85, on which the TCP is designated with A. When the actuator 90 rests against an end stop, the pose of the TCP also defines the pose of the grinding machine 50 (as well as that of the grinding disc 51). As previously mentioned, the actuator 90 serves the purpose of adjusting the contact force (processing force) between the tool and the work piece 60 to a desired value. Transferring the force directly by means of the manipulator 80 is too inexact for most applications as the high mass inertia of the segments 83 to 85 of the manipulator 80 make a quick compensation of force peaks (i.e. which occur when the grinding tool is pressed against the work piece 60) using conventional manipulators virtually impossible. For this reason, the robot controller 70 is configured to adjust the pose (position and orientation) of the TCP of the manipulator 80, whereas the force control is realized exclusively with the aid of the actuator 90.

As previously mentioned, during the grinding process, the contact force FK between the grinding tool (grinding machine 50 with grinding disc 51) and the work piece 60 can be adjusted with the aid of the linear actuator 90 and a force adjuster (which, for example, may be implemented in the controller 70) such that the contact force F_{K} (in the direction of the longitudinal axis A) between the grinding disc 51 and the work piece 60 corresponds to a specifiable desired value. Here the contact force F_{K} is a reaction to the actuator force F_{A} with which the linear actuator 90 presses against the surface of the work piece. In the absence of a contact between the work piece 60 and the tool 51, the actuator 90, due to the lack of contact force on the work piece 60, moves until it comes to rest against an end stop (not shown, integrated in the actuator 2) and presses against it with a defined force. While this takes place, the force control is active the entire time. In this situation (no contact), the actuator deflection is therefore at its maximum and the actuator 90 is in its resting position. The defined force with which the actuator 90 presses against the end stop may be very small or (theoretically) even zero in order that the contacting of the work piece surface is conducted as gently as possible.

The position control of the manipulator 80 (which may also be implemented in the controller 70) can operate completely independently of the force control of the actuator 90. The actuator 90 is not responsible for positioning the grinding machine 50, but only for adjusting and maintaining the desired contact force F_{K} during the grinding process and for detecting when contact between the tool 51 and the work piece 60 occurs. Detecting this contact may be realized simply based on the movement of the actuator out of its resting position (the actuator deflection a at the end stop is smaller than the maximum deflection a_{MAX}).

The actuator 90 may be a pneumatic actuator, e.g. a double-acting pneumatic cylinder. Other pneumatic actuators, however, may also be used such as, e.g. bellow cylinders and air muscles. As a further alternative, an electric (gearless) direct drive may also be considered. It should also be self-evident that the effective direction of the actuator 90 and the axis of rotation of the grinding machine 50 need not necessarily coincide with the longitudinal axis A of segment 85 of the manipulator 80. In the case in which a pneumatic actuator is used, the force can be controlled in a conventional manner with the aid of a control valve, a regulator (e.g. implemented in the controller 70) and with a tank of compressed air or a compressor. Since the inclination to the perpendicular is relevant when taking into consideration the gravitational force (i.e. the force of the weight of the grinding machine 50), the actuator 2 may be equipped with an inclination sensor, or the same information can be inferred based on the joint angles of the manipulator 80. The detected inclination is taken into consideration by the force controller. The specifics as to how a force control can be implemented are generally known and are of little relevance to the further discussion; they will therefore not be described here in detail. Not only does the actuator 90 provide a degree of mechanical decoupling between the manipulator 80 and the workpiece 60, it is also capable of compensating for inaccuracies in the positioning of the TCP.

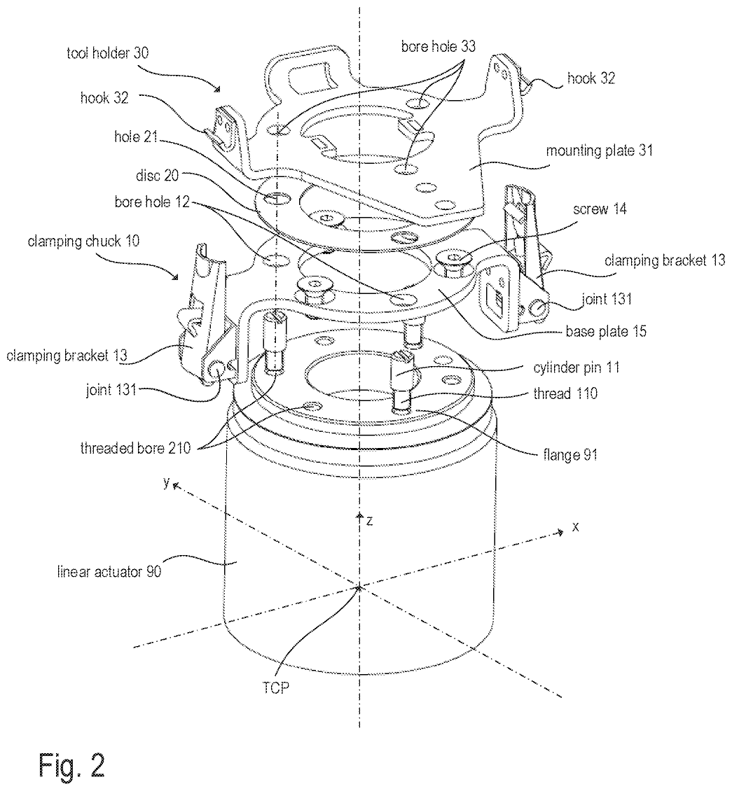

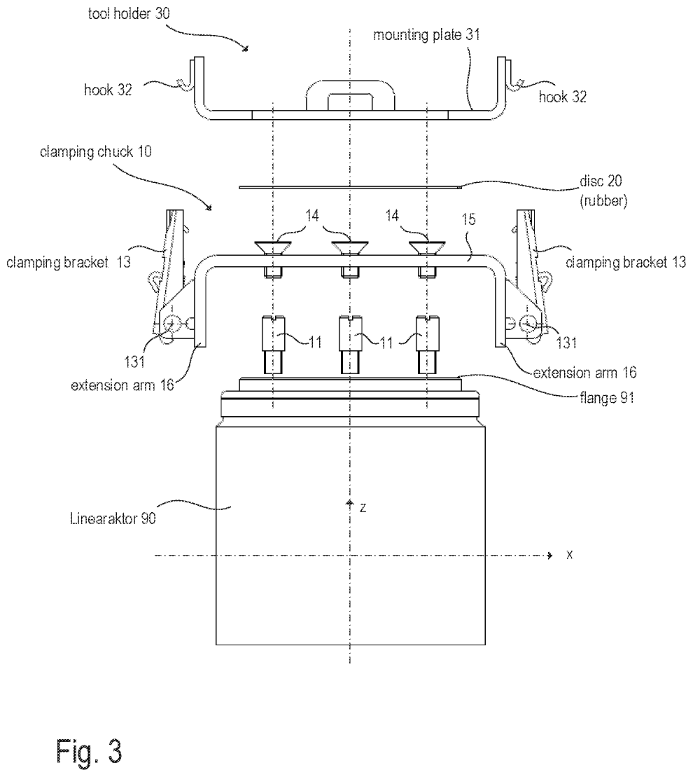

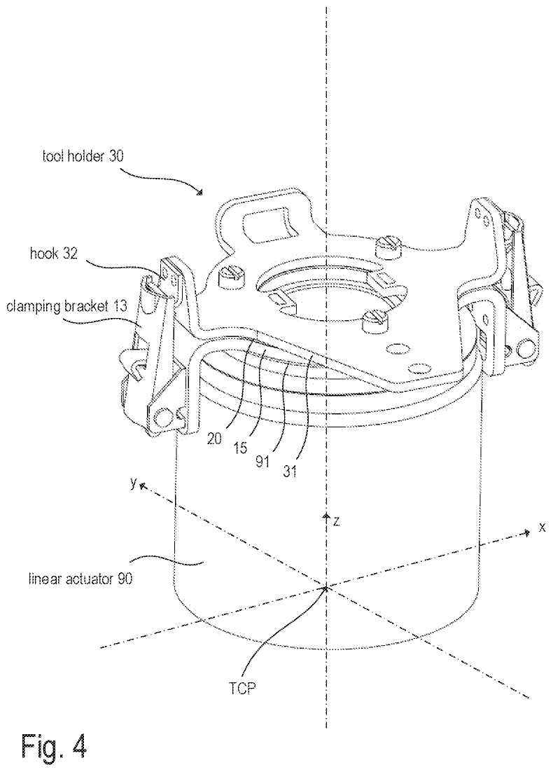

FIG. 2 illustrates an exemplary implementation of a rapid clamping system that make it possible to quite easily attach, and then detach, a machine tool such as, e.g. a grinding machine, a polishing machine or a milling machine, to and from a robot. FIG. 2 also shows part of the aforementioned linear actuator 90, one end of which is coupled to the end effector flange 86 (on the distal arm segment 85 of the robot, see FIG. 1) and the other end of which itself comprises a flange 91 for mounting a machine tool. The actuator 90 is therefore sometimes referred to as the “active flange”, in view of the fact that it can actively adjust a force between the end effector flange and the machine tool. FIG. 3 is a lateral view of the illustration in FIG. 2. FIG. 4 shows a perspective illustration of the assembled rapid clamping system in a locked state.

The rapid clamping system in accordance with FIG. 2 essentially comprises a clamping chuck 10, which can be mechanically coupled to the flange 91 (e.g. using screws), an elastic element, which in the present example is implemented as a rubber disc 20, as well as a tool holder 30, which may be mechanically and rigidly coupled to a machine tool. Materials suitable to be used for the disc 20 may include, in addition to rubber, plastic, in particular an elastomer. The flange 91 comprises numerous threaded bores 210. In the illustrated example, the flange 91 comprises six threaded bores 210, whereby cylinder pins 11 are screwed into three of the threaded bores 210. An upper section of the cylinder pins 11 is of a cylindrical shape and a lower section is provided with a screw thread 110 which can be screwed into the threaded bores 210. Cylinder pins are often also referred to as dowel pins. In place of a screw connection, cylinder pins (without screw threads) may also be glued or pressed into the corresponding bores. The inserted cylinder pins 11 serve as guides for the tool holder 30, in particular in order to prevent a tipping of the tool holder 30 relative to the z-axis (the perpendicular axis on the plane of the base plate 15, see FIG. 2). Generally speaking, the pins 11 serve to prevent a movement of the mounting plate 31 of the tool holder 30 relative to the base plate 15 of the clamping chuck 10 along a plane (xy plane) parallel to the base plate plane, whereas a degree of movement normal to this plane is allowed.

The clamping chuck 10 essentially comprises a base plate 15 and two or more clamping brackets 13, mounted on its lateral sides. The base plate 15 comprises numerous holes 12 (generally bore holes). In the example from FIG. 3 the base plate 15 has six holes, whereby the cylinder pins 11 screwed into the flange 91 extend through three of the holes, thereby maintaining the position of the clamping chuck. The other three holes 12 are for screws 14 which are screwed into corresponding threaded bores 21 in order to fix the base plate 15 to the flange 91. In the example from FIG. 2, each of the six threaded bores 210 are offset at 60° to each other, consequently, each of the three cylinder pins 11 and of the three screws 14 may be arranged offset at 120° to each other (relative to the z axis).

The base plate 15 comprises, on it sides, two extension arms 16, which project towards the flange 91 and which form, together with the base plate 15, an angle of essentially 90° (see FIG. 3). The clamping brackets 13 are mounted on these extension arms (e.g. by means of screws). Here it should be noted that, as an alternative, the cylinder pins 11 may also be mounted on the base plate 15 (e.g. screwed into it, instead of into the flange 91). For the maintenance of required tolerances, however, the variation illustrated in FIG. 2, in which the cylinder pins 11 are screwed into the flange 91, may be better (depending on the specific application). In order to fulfill their intended function, the cylinder pins 11 must extend from the base plate 15 at a right angle.

The tool holder 30 is rigidly attached to a machine tool (not illustrated in FIGS. 2-4). The specific construction of the tool holder 30 depends on the machine tool. In particular those parts of the tool holder 30 which serve to fix the tool holder onto the machine tool are variable and must be adapted to the respective machine tool. In effect, the tool holder 30 comprises a kind of interface which enables the machine tool to be clamped into the clamping chuck 10. The machine tool 30 comprises a mounting plate 31 with bore holes 33 and hooks 32. The mounting plate 31 matches the base plate 15 of the clamping chuck 10. In a mounted state, the mounting plate 31 of the tool holder 30 is attached to the cylinder pins 11 such that the cylinder pins 11 extend through the bore holes 33. The cylinder pins 11 thereby also define the position of the tool holder 30 (and thus the position of the machine tool) in the x and y directions (i.e. perpendicular to the z axis in the xy plane). In a clamped state, the mounting plate 32 of the tool holder rests against the base plate 15 of the clamping chuck 10 and the clamping brackets 13 are hooked and clamped in their respective hooks 32 (the hook is sometimes also referred to as keeper). Together, the clamping bracket 13 and the hook thus form a draw latch. An elastic element—in the illustrated example a rubber disc 20 arranged between the base plate 15 and the mounting plate 32—allows for a small resilient displacement of the tool holder 30 in the z direction relative to the clamping chuck 10. The elastic element (e.g. rubber disc 20) may deform when the draw latch is closed (the rubber disc 20 is squeezed) and provides for a pretensioning of the draw latch. In other words, in the clamped state, the clamping brackets 13 pull on their respective hooks 32 (and vice versa). At the same time, the elastic element/rubber disc 20 is held in a deformed, preloaded state. Clamping brackets 13 and their respective hooks 32 are well known and commercially widely available and will therefore not be described here further.

The draw latches, each of which is comprised of a clamping bracket 13 and a hook 31 in combination with an elastic element, are also sometimes referred to as over center latches because the clamping bracket 13, when closed, after having been hung into its corresponding hook 32, is swung around the joint 131 up to the dead center of the swivel movement and beyond the dead center. This reliably protects the draw latch/over center latch from being unintentionally released, as the clamping bracket 13 cannot be moved back again across the dead center without applying external force. This external force has to be applied manually by an operator while locking and releasing the draw latch.

It should be noted here that the rubber disc 20 is only one example of an elastic element. In general, any elastic element is suitable, as long as it is arranged (somewhere in the rapid clamping system) such that it becomes elastically deformed when the draw latches (clamping bracket 13 and hook 32) are closed and, while in the closed state, maintains a preloading force in the z direction between the clamping chuck 10 and the tool holder 30 which is transferred to the draw latches. This resilient deformation allows for a small movement of the tool holder 30 in the z direction relative to the clamping chuck 10, whereas it blocks a relative movement of the cylinder pins 11 that serve as a linear guide in the directions x and y. As an alternative to the rubber disc 20, one or more elastic elements may instead be integrated in the clamping brackets 13 or the hooks 32, in which case the rubber disc 20 can be omitted. For example, the hooks 32 and/or a part of the clamping brackets 13 may themselves be formed (at least partially) of an elastic or otherwise yielding material. In such cases one sometimes also refers to flexible draw latches or tension strap closures. As an alternative, the clamping brackets 13 may be mounted, elastically and moveably in the z direction, on the extension arms 16 of the base plate 15 using a spring. Additionally or alternatively, the hooks 32 may be mounted elastically moveably on the mounting plate 31 by means of a spring element or some other elastic element. Additionally or alternatively, the bearing bushes of the joints 131 of the clamping brackets 13 may also be made of an elastic material and allow for the aforementioned elastic deformation when the draw latches are closed.

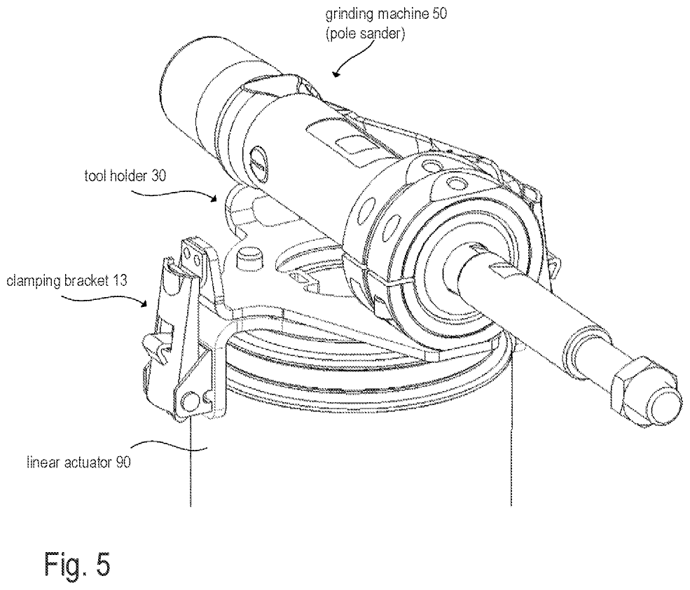

FIG. 5 shows a linear actuator 90 mounted on a robot (not shown in FIG. 5, see FIG. 1) with a locked rapid clamping system in accordance with the examples of FIGS. 2-4, in which a pole sander 50 is attached to the tool holder 30. As mentioned earlier, the tool holder 30 serves as an interface for clamping the machine tool onto the clamping chuck 10 of the rapid clamping system.

The rapid clamping system described here can be employed, in particular, with robots that are capable of adjusting the contact force between the tool and the work piece surface. As mentioned previously, this force regulation can either be carried out with the aid of the actuator 90 or—provided the robot is suitably equipped—by the robot itself—in which case the actuator 90 may also be omitted and the clamping chuck 10 may be mounted directly on the end effector flange 86 (cf. FIG. 1) instead of on the flange 91 of the actuator 90. In both cases (with or without the actuator 90), the contact force (processing force) is regulated during the surface machining process, whereby, during the machining process, the z direction shown in FIGS. 2-4 generally extends normal to the surface of the work piece and the z direction is also the effective direction of the regulated contact force. Possible inaccuracies in the positioning of the machine tool in the z direction are compensated for by the force control, as the machine tool is always pressed against the work piece with a defined, regulated force. For this reason, inaccuracies in the position of the machine tool that result from the deformation of the elastic element (e.g. of the rubber disc 20) are irrelevant in practical applications; these inaccuracies are also virtually automatically compensated for by the force control. In the event that a torque should affect the rapid clamping system, this can still not result in a significant tilting or in a xy displacement of the tool holder 30 relative to the clamping chuck 10 as such a movement is prevented by the cylinder pins 11 extending into the bore holes 33. Any torque will thus be absorbed by the rapid clamping system. The only degree of freedom is a (very small) resilient displacement in the z direction which, as explained, is compensated for by the force control.

In conclusion is should be noted that the positions of the hook 32 and of the clamping bracket 13 are interchangeable, although, in practice, it will probably make more sense to mount the clamping brackets on the base plate of the clamping chuck 10 (and not on the mounting plate 13 of the tool holder 30). It is equally irrelevant whether or not the cylinder pins are immovable relative to the base plate 15 of the clamping chuck 10 or whether or not they are inserted into and through corresponding holes in the clamping chuck 10, as illustrated in FIG. 2. Neither do the pins (11) necessarily need to be separate parts; they could theoretically be formed in one piece together with the base plate 15 or the mounting plate 31 (although this would be more complicated to produce). In such a case the base plate (or mounting plate) and the pins would be an integral component. The pins do not have to be cylinder shaped either—any shape is possible that can engage with a corresponding opening in the opposite part and block a movement in a plane parallel to the base plate, while allowing for a small movement perpendicular to the plate.

In a further example, the linear actuator 90 is not mounted, together with the rapid clamping system and the machine tool, on a manipulator (industrial robot), but on an immovable (stationary) base. In this case the work piece is held by the robot and is positioned such that the machine tool can contact and machine the work piece held by the robot. The robot operates in a position-controlled manner and moves the work piece along a previously specified trajectory during the machining process, while the linear actuator 90 mounted on the stationary base carries out the force adjustment and presses the machine tool against the work piece held by the robot. Examples of such systems—albeit without a rapid clamping system—are described in the publication US 2018/0126512 A1.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although various embodiments have been illustrated and described with respect to one or more specific implementations, alterations and/or modifications may be made to the illustrated examples without departing from the spirit and scope of the appended claims. With particular regard to the various functions performed by the above described components or structures (units, assemblies, devices, circuits, systems, etc.), the terms (including a reference to a “means”) used to describe such components are intended to correspond—unless otherwise indicated—to any component or structure that performs the specified function of the described component (e.g., that is functionally equivalent), even if it is not structurally equivalent to the disclosed structure that performs the function in the herein illustrated exemplary implementations of the invention.

It will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1-10. (canceled)

11. A rapid clamping system, comprising:
a clamping chuck having a base plate, and which is configured to be mounted on a flange which is a force-controlled positionable by a manipulator or a linear actuator;
a tool holder configured to be mounted on a machine tool, wherein the tool holder comprises a mounting plate which, when in a locked state, rests against the base plate;
two or more pins configured, when in a mounted state, to align the mounting plate on the base plate and to prevent a movement of the mounting plate relative to the base plate in a plane parallel to the base plate;
at least one elastic element; and
a draw latch configured to lock the tool holder on the base plate of the clamping chuck such that in a locked state, the at least one elastic element is deformed and effects a pretension force between the base plate and the mounting plate.

12. The rapid clamping system of claim 11, wherein the at least one elastic element comprises a disc of an elastic material which is arranged between the base plate and the mounting plate.

13. The rapid clamping system of claim 11, wherein the at least one elastic element is a part of the draw latch.

14. The rapid clamping system of claim 11, wherein the draw latch comprises a plurality of clamping brackets and a plurality of hooks assigned to the clamping brackets.

15. The rapid clamping system of claim 14, wherein the hooks are mounted on the tool holder and the clamping brackets are swivel mounted on the base plate.

16. The rapid clamping system of claim 14, wherein the hooks are mounted on the base plate and the clamping brackets are swivel mounted on the tool holder.

17. The rapid clamping system of claim 11, wherein the two or more pins, when in a mounted state, extend to corresponding holes in the mounting plate.

18. The rapid clamping system of claim 11, wherein the two or more pins, when in a mounted state, extend to corresponding holes in the base plate.

19. The rapid clamping system of claim 11, wherein the two or more pins are mounted on the flange and extend through corresponding holes of the base plate and the mounting plate.

20. The rapid clamping system of claim 11, wherein the draw latch comprises an over center latch.

21. An apparatus for robot-supported machining of a surface of a work piece, the apparatus comprising:
the rapid clamping system of claim 11, wherein the force-controlled positionable is a first flange of the linear actuator; and
a manipulator, wherein a second flange of the linear actuator is coupled to an end effector flange of the manipulator,
wherein the manipulator is configured to position the linear actuator, together with the machine tool which is coupled to the linear actuator by the rapid clamping system, in a position-controlled manner relative to the work piece and the linear actuator is configured to adjust a force between the machine tool and the work piece.

22. An apparatus for robot-supported machining of a surface of a work piece, the apparatus comprising:
the rapid clamping system of claim 11, wherein the force-controlled positionable is a first flange of the linear actuator;
a stationary base on which a second flange of the linear actuator is mounted; and
a manipulator configured to hold the work piece and to position the work piece relative to a machine tool coupled to the linear actuator by the rapid clamping system,
wherein the linear actuator is configured to adjust a force between the machine tool and the work piece.
